(19) United States
(12) Patent Application Publication
(10) Pub. No.: US 2010/0072671 A1
(43) Pub. Date: Mar. 25, 2010

(54) NANO-IMPRINT LITHOGRAPHY TEMPLATE FABRICATION AND TREATMENT

(75) Inventors: Gerard M. Schmid, Austin, TX (US); Weijun Liu, Cedar Park, TX (US); Edward Brian Fletcher, Austin, TX (US); Frank Y. Xu, Round Rock, TX (US); Fen Wan, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/567,275

(22) Filed: Sep. 25, 2009

Related U.S. Application Data
(60) Provisional application No. 61/099,955, filed on Sep. 25, 2008.
(60) Provisional application No. 61/110,739, filed on Nov. 3, 2008.

(51) Int. Cl. B29C 43/02; B29C 35/00

(52) U.S. Cl. 264/402; 425/470; 204/158.2

(57) ABSTRACT

A nano-imprint lithography template includes a rigid support layer, a cap layer, and a flexible cushion layer positioned between the support layer and the cap layer. Treating an imprint lithography template includes heating the template to desorb gases from the template. Heating the template includes radiating the template at a selected wavelength with, for example, infrared radiation. The selected wavelength may correspond to a wavelength at which the template material is strongly absorbing.

### CROSS-REFERENCE TO RELATED APPLICATIONS

This application claims the benefit under 35 U.S.C. §119(e)(1) of U.S. provisional application 61/099,955, filed Sep. 25, 2008, and U.S. provisional application 61/110,739 filed Nov. 3, 2008, both of which are hereby incorporated by reference herein.

### TECHNICAL FIELD

This invention is related to fabrication of nano-imprint lithography templates and treatment thereof.

### BACKGROUND

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An example nano-fabrication technique in use today is commonly referred to as imprint lithography. Example imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes formation of a relief pattern in a formable (polymerizable) layer and transferring a pattern corresponding to the relief pattern into an underlying substrate. The substrate may be coupled to a motion stage to facilitate positioning for the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### SUMMARY

In one aspect, a nano-imprint lithography template includes a rigid support layer, a nano-imprint lithography cap layer having features configured to imprint a pattern within a polymerizable fluid, and a flexible cushion layer positioned between the support layer and the cap layer.

In some implementations, the cushion layer is configured to absorb forces from an uneven substrate during a nano-imprinting process such that the support layer is substantially undeformed during the process. The cushion layer may include an elastomer. In some cases, the cushion layer is substantially UV transparent.

In another aspect, a method of treating a nano-imprint lithography template in a nano-imprint lithography system includes heating the nano-imprint lithography template to remove adsorbed gas from the nano-imprint lithography template.

In some implementations, heating includes irradiating the template with radiation of a selected wavelength. The selected wavelength may correspond to an absorption band of the template. The template may include fused silica, and the radiation may be infrared radiation. In some cases, a wavelength of the infrared radiation is between about 2 microns and about 23 microns. In certain cases, the infrared radiation is selected from the group consisting of 2.8 microns, 5-6 microns, 9-10 microns, 21-23 microns, and any combination thereof. In some embodiments, heating includes irradiating with an infrared laser or irradiating with a filament source. Heating may include selectively heating near a surface of the template.

The template may be cooled after heating to desorb gases. Cooling may include contacting a surface with the template such that heat transfers from the template to the surface. The surface may include an imprint lithography substrate, and the substrate may be coupled to an imprint lithography system. In some cases, cooling includes contacting the template with a fluid. Contacting the template with a fluid may include immersing at least a portion of the template in the fluid.

In another aspect, a nano-imprint lithography method includes depositing a first portion of polymerizable material on a first nano-imprint lithography substrate, contacting the first portion of the polymerizable material with a nano-imprint lithography template coupled to a nano-imprint lithography system, solidifying the polymerizable material, and separating the template from the solidified material. The template may be heated to remove adsorbed gases from the template. The template may be cooled to ambient temperature. After the template has cooled, a second portion of polymerizable material may be deposited on a second nano-imprint lithography substrate. The second portion of the polymerizable material may be contacted with the cooled template; the polymerizable material may be solidified, and the template is separated from the solidified material. In some implementations, heating the template includes irradiating the template with infrared radiation. In some cases, the first substrate and the second substrate are the same.

### BRIEF DESCRIPTION OF THE DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system.

FIG. 2 illustrates a simplified side view of the substrate shown in FIG. 1 having a patterned layer positioned thereon.

FIG. 3 illustrates a side view of a volume, defined between the substrate and template of FIG. 1, having gases formed therein.

FIG. 4 illustrates magnified cross-sectional views of various porous templates.

FIG. 5 illustrates magnified cross-sectional views of various imprinting stacks.

FIG. 6 illustrates a nano-imprint lithography template with a cushion layer.

FIG. 7A illustrates an imprinting process on an even substrate.

FIG. 7B illustrates an imprinting process on an even substrate.

FIG. 8 illustrates a process of fabricating a template with a cushion layer.

FIG. 9 illustrates a template with a cap layer on the sides of a cushion layer.

FIG. 10 illustrates a side view of a template being exposed to wavelength λ by an energy source.

FIG. 11 illustrates a graphical representation of an example of mid-infrared absorbance of the template illustrated in FIG. 10.

FIG. 12 illustrates a graphical representation of an example of visible and near-infrared transmission of the template illustrated in FIG. 10.

FIG. 13 illustrates a graphical representation of an example of exposure intensity of the surface of the template illustrated in FIG. 10.

FIG. 14 illustrates a flow chart of an example method for selective heating of a template to desorb gases.

### DETAILED DESCRIPTION

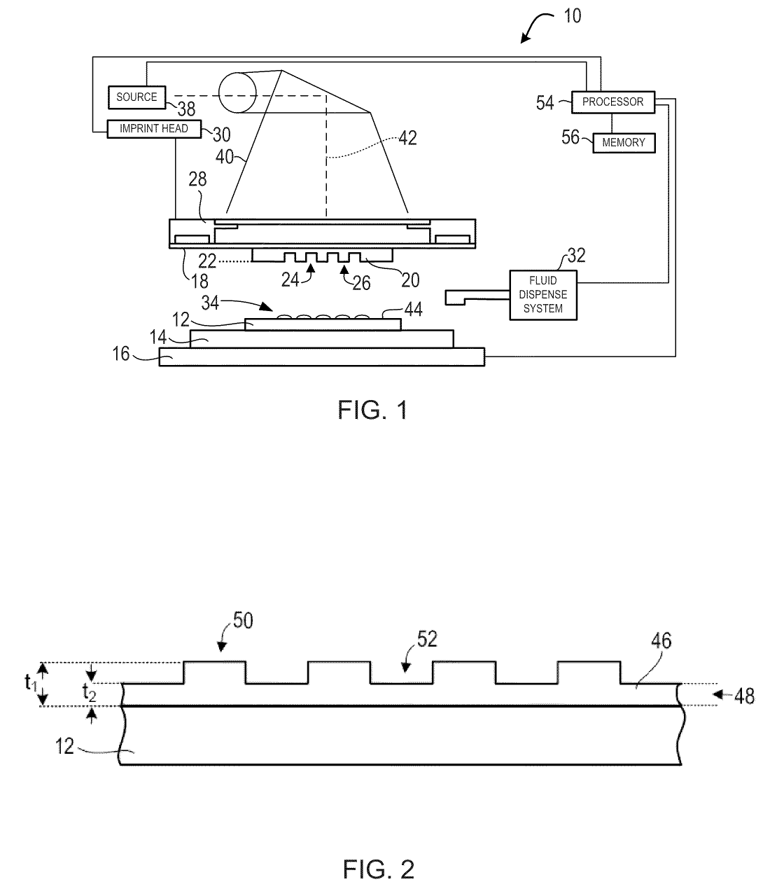

Referring to FIG. 1, illustrated therein is a lithographic system 10 used to form a relief pattern on substrate 12. An imprint lithography stack may include substrate 12 and one or more layers (e.g., an adhesion layer) adhered to the substrate. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and the like, or any combination thereof. Examples of chucks are described in U.S. Pat. No. 6,873,087, which is hereby incorporated by reference herein.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 may include a mesa 20 extending therefrom towards substrate 12, mesa 20 having a patterning surface 22 thereon. Further, mesa 20 may be referred to as mold 20. Template 18 and/or mold 20 may be formed from such materials including, but not limited to, fused-silica, quartz, silicon, organic polymers, siloxane polymers, borosilicate glass, fluorocarbon polymers, metal, hardened sapphire, and the like, or any combination thereof. As illustrated, patterning surface 22 includes features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Examples of chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further include a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and the like, or any combination thereof. Polymerizable material 34 (e.g., imprint resist) may be disposed upon substrate 12 before and/or after a desired volume is defined between mold 20 and substrate 12 depending on design considerations. Polymerizable material 34 may include components as described in U.S. Pat. No. 7,157,036 and U.S. Patent Application Publication No. 2005/0187339, both of which are hereby incorporated by reference herein.

Referring to FIGS. 1 and 2, system 10 may further include an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, source 38, or any combination thereof, and may operate on a computer readable program stored in memory 56.

Either imprint head 30, stage 16, or both may alter a distance between mold 20 and substrate 12 to define a desired volume therebetween that is substantially filled by polymerizable material 34. For example, imprint head 30 may apply a force to template 18 such that mold 20 contacts polymerizable material 34. After the desired volume is substantially filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may include a residual layer 48 and a plurality of features shown as protrusions 50 and recessions 52, with protrusions 50 having a thickness t₁ and residual layer 48 having a thickness t₂.

The above-described system and process may be further implemented in imprint lithography processes and systems referred to in U.S. Pat. No. 6,932,934, U.S. Patent Application Publication No. 2004/0124566, U.S. Patent Application Publication No. 2004/0188381, and U.S. Patent Application Publication No. 2004/0211754, each of which is hereby incorporated by reference herein.

In nano-imprint processes in which polymerizable material is applied to a substrate by drop dispense or spin coating methods, gases may be trapped inside recesses in the template after the template contacts the polymerizable material. In nano-imprint processes in which a multiplicity of drops of polymerizable material is applied to a substrate by drop dispense methods, gases may also be trapped between drops of polymerizable material or imprint resist dispensed on a substrate or on an imprinting stack. That is, gases may be trapped in interstitial regions between drops as the drops spread.

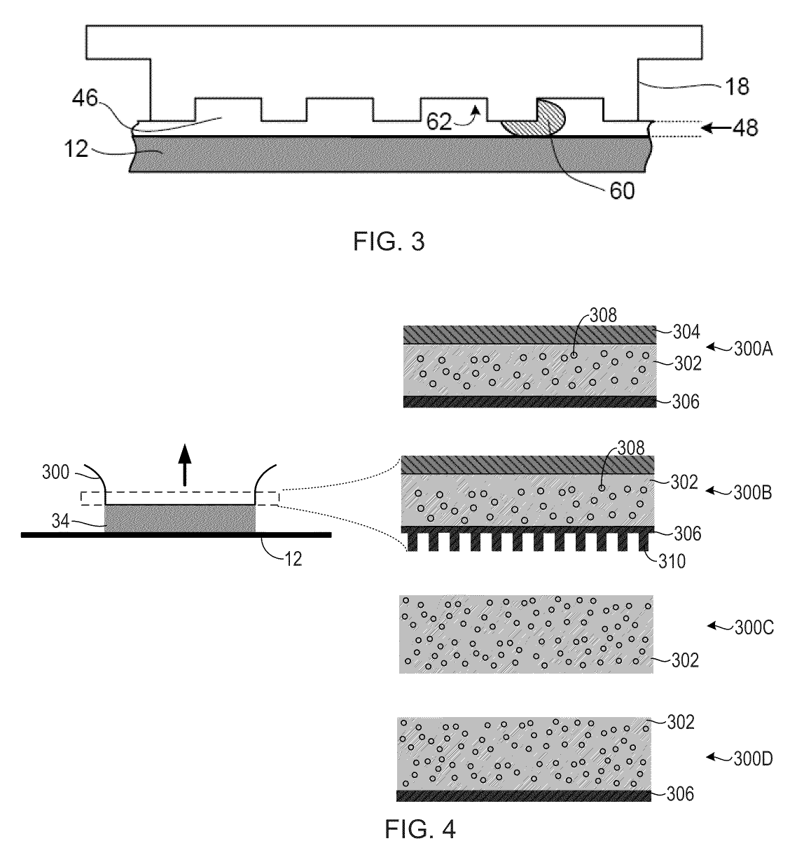

In the volume defined between substrate 12 and template 18, there may be gases and/or gas pockets present, as illustrated by FIG. 3. Gases and/or gas pockets are hereinafter referred to as gases 60. The gases 60 may include, but are not limited to, air, nitrogen, carbon dioxide, helium, and/or the like. Gases 60 between substrate 12 and template 18 may result in pattern distortion of features formed in patterned layer 46, low fidelity of features formed in patterned layer 46, non-uniform thickness of residual layer 48 across patterned layer 46, and/or the like.

Gas escape and dissolution rates may limit the rate at which the polymerizable material is able to form a continuous layer on the substrate (or imprinting stack) or the rate at which the polymerizable material is able to fill template features after the template contacts the polymerizable material, thereby limiting throughput in nano-imprint processes. For example, a substrate or a template may be substantially impermeable to a gas trapped between the substrate and the template. In some cases, a polymeric layer adhered to the substrate or the template may become saturated with gas, such that gas between the imprinting stack and the template is substantially unable to enter the saturated polymeric layer, and remains trapped between the substrate and the substrate or imprinting stack. Gas that remains trapped between the substrate or the imprinting stack and the template may cause filling defects in the patterned layer.

In an imprint lithography process, gas trapped between the substrate/imprinting stack and the template may escape through an edge of the polymerizable material, the substrate/imprinting stack, the template, or any combination thereof. The amount of gas that escapes through any medium may be influenced by the contact area between the trapped gas and the medium. The contact area between the trapped gas and the polymerizable material that is not bounded by the template or the substrate may be less than the contact area between the trapped gas and the substrate/imprinting stack and less than the contact area between the trapped gas and the template. For example, a thickness of the polymerizable material on a substrate/imprinting stack may be less than about 1 μm, or less than about 100 nm, providing a small area for gas to escape through the polymerizable material without going through the template or the substrate. In some cases, a polymerizable material may absorb enough gas to become saturated with the gas before imprinting, such that trapped gas is substantially unable to enter the polymerizable material. In contrast, the contact area between the trapped gas and the substrate or imprinting stack, or the contact area between the trapped gas and the template, may be relatively large.

In some cases, the substrate/imprinting stack or template may include a porous material defining a multiplicity of pores with an average pore size and pore density or relative porosity selected to facilitate diffusion of a gas into the substrate/imprinting stack or the template, respectively. In certain cases, the substrate/imprinting stack or template may include one or more layers or regions of a porous material designed to facilitate transport of gases trapped between the substrate/imprinting stack and the template in a direction away from the polymerizable material between the substrate/imprinting stack and substrate and toward the substrate/imprinting stack or the template, respectively.

The gas permeability of a medium may be expressed as P=D×S, in which P is the permeability, D is the diffusion coefficient, and S is the solubility. In a gas transport process, a gas adsorbs onto a surface of the medium, and a concentration gradient is established within the medium. The concentration gradient may serve as the driving force for diffusion of gas through the medium. Gas solubility and the diffusion coefficient may vary based on, for example, packing density of the medium. Adjusting a packing density of the medium may alter the diffusion coefficient and hence the permeability of the medium.

A gas may be thought of as having an associated kinetic diameter. The kinetic diameter provides an idea of the size of the gas atoms or molecules for gas transport properties. D. W. Breck, Zeolite Molecular Sieves—Structure, Chemistry, and Use, John Wiley & Sons, New York, 1974, p. 636, which is hereby incorporated by reference herein) lists the kinetic diameter for helium (0.256 nm), argon (0.341 nm), oxygen (0.346 nm), nitrogen (0.364 nm), and other common gases.

In some imprint lithography processes, a helium purge is used to substantially replace air between the template and the substrate or imprinting stack with helium gas. To simplify the comparison between a helium environment and an air environment in an imprint lithography process, the polar interaction between oxygen in air and silica may be disregarded by modeling air as pure argon. Both helium and argon are inert gases, and argon has a kinetic diameter similar to that of oxygen. Unlike oxygen, however, helium and argon do not interact chemically with fused silica or quartz (e.g., in a template or substrate).

Internal cavities (solubility sites) and structural channels connecting the solubility sites allow a gas to permeate through a medium. The gas may be retained in the solubility sites. The size of the internal cavities and the channel diameter relative to the size (or kinetic diameter) of the gas influence the rate at which the gas permeates the medium.

The sizes of individual interstitial solubility sites of fused silica have been shown to follow a log-normal distribution by J. F. Shackelford in J. Non-Cryst. Solids 253, 1999, 23, which is hereby incorporated by reference herein. As indicated by the interstitial diameter distribution (mode=0.181 nm; mean=0.196 nm) and the kinetic diameter of helium and argon, the number of fused silica solubility sites available to helium exceeds the number of solubility sites available to argon. The total number of interstitial sites is estimated to be 2.2×10²⁸ per m³, with 2.3×10²⁷ helium solubility sites per m³ and 1.1×10²⁶ argon solubility sites per m³. The average distance between solubility sites for helium is considered to be 0.94 nm, while the average distance between solubility sites for argon is considered to be 2.6 nm. The structural channels connecting these solubility sites are thought to be similar to the helical arrangement of 6-member Si—O rings, with a diameter of about 0.3 nm. Table 1 summarizes some parameters affecting helium and argon permeability in fused silica.

TABLE 1

| | Helium | Argon |
|---|---|---|
| Kinetic Diameter (nm) | 0.256 | 0.341 |
| Solubility Site Density (m⁻³) | 2.3 × 10²⁷ | 1.1 × 10²⁶ |
| Distant Between Solubility Sites (nm) | 0.94 | 2.6 |
| Structural Channel Diameter | ~0.3 | ~0.3 |
| Connecting Solubility Sites (nm) | | |

Boiko (G. G. Boiko, etc., Glass Physics and Chemistry, Vol. 29, No. 1, 2003, pp. 42-48, which is hereby incorporated by reference herein) describes behavior of helium in amorphous or vitreous silica. Within a solubility site, the helium atom vibrates at an amplitude allowed by the interstitial volume. The atom passes from interstice to interstice through channels, which may be smaller in diameter than the interstices.

The parameters listed in Table 1 indicate that argon permeability in fused silica may be very low or negligible at room temperature (i.e., the kinetic diameter of argon exceeds the fused silica channel size). Since the kinetic diameters of oxygen and nitrogen are larger than the kinetic diameter of argon, air may be substantially unable to permeate fused silica. On the other hand, helium may diffuse into and permeate fused silica. Thus, when a helium environment is used rather than ambient air for a nano-imprint process, helium trapped between the template and the substrate or imprinting stack may be able to permeate a fused silica template.

FIG. 4 is a side view of polymerizable material 34 between substrate 12 and porous template 300, along with enlarged cross-sectional views of various porous template embodiments for use in nano-imprint lithography. The arrow indicates the direction of gas transport into template 300.

Template 300A includes a porous layer 302 between base layer 304 and cap layer 306. Porous layer 302 may be formed by chemical vapor deposition (CVD), spin-coating, thermal growth methods, or the like on base layer 304. A thickness of porous layer 302 may be at least about 10 nm. For example, a thickness of porous layer 302 may be in a range of about 10 nm to about 100 μm, or in a range of about 100 nm to about 10 μm. In some cases, a thicker porous layer 302 may provide higher effective permeability, without significantly reducing performance related to, for example, UV transparency, thermal expansion, etc.

Porous layer 302 may be made from materials including, but not limited to anodized α-alumina; organo-silane, organo-silica, or organosilicate materials; organic polymers; inorganic polymers, and any combination thereof. In some embodiments, the porous material may be low-k, porous low-k, or ultra-low-k dielectric film, such as spin-on glass (SOG) used in electronic and semiconductor applications. The porous material may be selected to withstand repeated use in nano-imprint lithography processes, including Piranha reclaim processes. Adhesion of the porous layer 302 to the base layer 304 and the cap layer 306 may be, for example, at least about three times the force required to separate the template from the patterned layer formed in an imprint lithography process. In some embodiments, the porous material may be substantially transparent to UV radiation. A tensile modulus of the porous material may be, for example, at least about 2 GPa, at least about 5 GPa, or at least about 10 GPa.

By varying the process conditions and materials, porous layers with different pore size and pore density (e.g., porosity or relative porosity) may be produced. In some cases, for example, ion bombardment may be used to form pores in a material. Porous layer 302 may have pores 308 with a larger pore size and a greater porosity than fused silica. As used herein, “porosity” refers to the fraction, as a percent of total volume, occupied by channels and open spaces in a solid. The porosity of porous layer 302 may range from about 0.1% to about 60%, or from about 5% to about 45%. In some cases, the porosity of porous layer 302 may be at least about 10% or at least about 20%. The relative porosity of similar materials may be defined as a relative difference in density of the materials. For example, a relative porosity of SOG (density ρ_{SOG}=1.4 g/cm³) with respect to fused silica (density ρ_{fused silica}=2.2 g/cm³) may be calculated as 100%×(ρ_{fused silica}−ρ_{SOG})/ρ_{fused silica}, or 36%. Fused silica may be used as a reference material for other materials including oxygen-silicon bonds. In some embodiments, a relative porosity of a porous material including oxygen-silicon bonds with respect to fused silica is at least about 10%, at least about 20%, or at least about 30%.

Sizes of the pores in a porous material may be well-controlled (e.g., substantially uniform, or with a desired distribution). In some cases, a pore size or average pore size is less than about 10 nm, less than about 3 nm, or less than about 1 nm. In some cases, the pore size or average pore size is at least about 0.4 nm, at least about 0.5 nm, or larger. That is, the pore size or average pore size may be large enough to provide a sufficient number of solubility sites for a gas, such that the gas, when trapped between the substrate/imprinting stack and the template 300A, is able to diffuse into porous layer 302 of the template.

Porogens may be added to material used to form porous layer 302 to increase the porosity and pore size of the porous layer. Porogens include, for example, organic compounds that may be vaporized, such as norbornene, α-terpinene, polyethylene oxide, and polyethylene oxide/polypropylene oxide copolymer, and the like, and any combination thereof. Porogens may be, for example, linear or star-shaped. Porogens and process conditions may be selected to form a microporous low-k porous layer, for example, with an average pore diameter of less than about 2 nm, thereby increasing the number of solubility sites for a range of gases. In addition, the introduction of porogens and the increased porosity may enlarge the structure channels connecting gas solubility sites. For pore sizes of about 0.4 nm or greater, helium permeability of a low-k film may exceed helium permeability of vitreous fused silica.

Base layer 304 and cap layer 306 may be made of the same or different material. In some embodiments, base layer 304 may be fused silica and cap layer 306 may include SiOₓ, with 1≦x≦2, grown through a vapor deposition method. A thickness and composition of cap layer 306 may be chosen to provide mechanical strength and selected surface properties, as well as permeability to gases that may be trapped between a substrate/imprinting stack and a template in an imprint lithography process. In some embodiments, a thickness of cap layer 306 is less than about 100 nm, less than about 50 nm, or less than about 20 nm. In an example, cap layer 306 is about 10 nm thick. Cap layer 306 may be formed by material selected to achieve desirable wetting and release performance during an imprint lithography process. Cap layer 306 may also inhibit penetration of polymerizable material 34 into the porous layer while allowing gas to diffuse through the cap layer and into the porous layer 302.

For a multi-layer film, effective permeability may be calculated from a resistance model, such as an analog of an electric circuit described by F. Peng, et al. in J. Membrane Sci. 222 (2003) 225-234 and A. Ranjit Prakash et al. in Sensors and Actuators B 113 (2006) 398-409, which are both hereby incorporated by reference herein. The resistance of a material to the permeation of a vapor is defined as the permeance resistance, Rₚ. For a two-layer composite film with layer thicknesses l₁ and l₂, and corresponding permeabilities P₁ and P₂, permeance resistance may be defined as Rₚ=Δp/J=1/[(P/l)A], in which Δp is the pressure difference across the film, J is the flux, and A is the area. The resistance model predicts Rₚ=R₁+R₂. When the cross-sectional area is the same for both materials 1 and 2, this may be rewritten as l₁+l₂)/P=+l₁/P₁+l₂/P₂.

For template 300A with cap layer 306 of SiOₓ with a thickness of about 10 nm and permeability P₁, template permeability may be adjusted by selecting porosity and pore size of the porous layer 302. The effect of the permeability and thickness of porous layer 302 on the effective permeability of a multi-layer composite imprinting stack with a thickness of 310 nm is shown in Table 2.

TABLE 2

| Cap Layer | | Base Layer | | Effective | |
|---|---|---|---|---|---|
| Thickness | Porous Layer | Thickness | | Permeability | |
| (SiOₓ), | Thickness, | (SiO₂), | Permeability | of the | |
| Permeability P₁ | Permeability P₂ | Permeability P₁ | Ratio | Total Stack | |
| 10 nm | 300 nm | 0 | P₂ = 1000 P₁ | 30.1 | P₁ |
| 10 nm | 200 nm | 100 nm | P₂ = 1000 P₁ | 2.8 | P₁ |
| 10 nm | 100 nm | 200 nm | P₂ = 1000 P₁ | 1.5 | P₁ |
| 10 nm | 300 nm | 0 | P₂ = 100 P₁ | 23.8 | P₁ |

Table 2 suggests that increasing a thickness of the porous layer alone may yield a higher effective permeability than increasing the permeability of the porous layer alone. That is, for a porous layer thickness of 300 nm and a cap layer thickness of 10 nm, a ten-fold increase in permeability of the porous layer from 100 P₁ to 1000 P₁ increases the effective permeability from 23.8 P₁ to 30.1 P₁. For composite imprinting stacks with a porous layer thickness of 100 nm, 200 nm, and 300 nm and a cap layer thickness of 10 nm, the effective permeability increases twenty-fold, from 1.5 P₁ to 2.8 P₁ to 30.1 P₁, respectively, over the 200 nm increase in porous layer thickness.

In another embodiment, protrusions 310 may extend from cap layer 306. In an example, template 300B may be formed by depositing a 500 nm thick porous layer (e.g., an organosilicate low-k film) on a base layer (e.g., quartz), and growing a 100 nm thick cap layer (e.g., SiOₓ) on top of the porous layer. The cap layer is etched back to form protrusions 90 nm in height. As used herein, a thickness of cap layer 306 is considered independently of the height of the protrusions 310. Thus, the cap layer in this example is considered to be 10 nm thick, with protrusions 90 nm in height extending from the cap layer. At least about 50% of the template surface has a 10 nm thick covering of SiOₓ (i.e., about 50% of the template surface area is covered with protrusions) with a 500 nm thick porous layer underneath. Helium may diffuse more quickly through portions of the cap layer from which there are no protrusions, achieving an overall increase in helium permeability at least partially dependent on the thickness of the porous layer, the thickness of the cap layer, and the fraction of the surface area of the template free from protrusions.

A template may be formed as a unitary structure with a porosity and average pore size selected to allow diffusion of a gas. Templates made from, for example, organic polymers, inorganic materials (e.g., silicon carbide, doped silica, VYCOR®), and the like, or any combination thereof, may have a lower packing density, and therefore a higher gas (e.g., helium) permeability, than vitreous fused silica. FIG. 4 illustrates template 300C. Template 300C is essentially a single porous layer 302. The porous layer 302 is not adhered to a base layer. The porous layer may have an average pore size of at least about 0.4 nm and a porosity of at least about 10%.

Template 300D includes porous layer 302 with a cap layer 306. Cap layer 306 may be, for example, SiOₓ. As with template 300C, the porous layer is not adhered to a base layer. The cap layer 306 may inhibit penetration of the polymerizable material into the porous material. The cap layer 306 may also impart desirable surface properties, mechanical properties, and the like to the template.

An imprinting stack may include a substrate and a layer adhered to the substrate. Multi-layer imprinting stacks may include one or more additional layers adhered together to form a multi-layer composite. The substrate may be, for example, a silicon wafer. A layer adhered to the substrate may include, for example, organic polymeric material, inorganic polymeric material, or any combination thereof. Pore size and porosity of the substrate, the layers, or any combination thereof may be selected to allow diffusion of a gas (e.g., helium) through the imprinting stack, thus enhancing filling performance by facilitating reduction of trapped gases and filling of features in the template during an imprint lithography process.

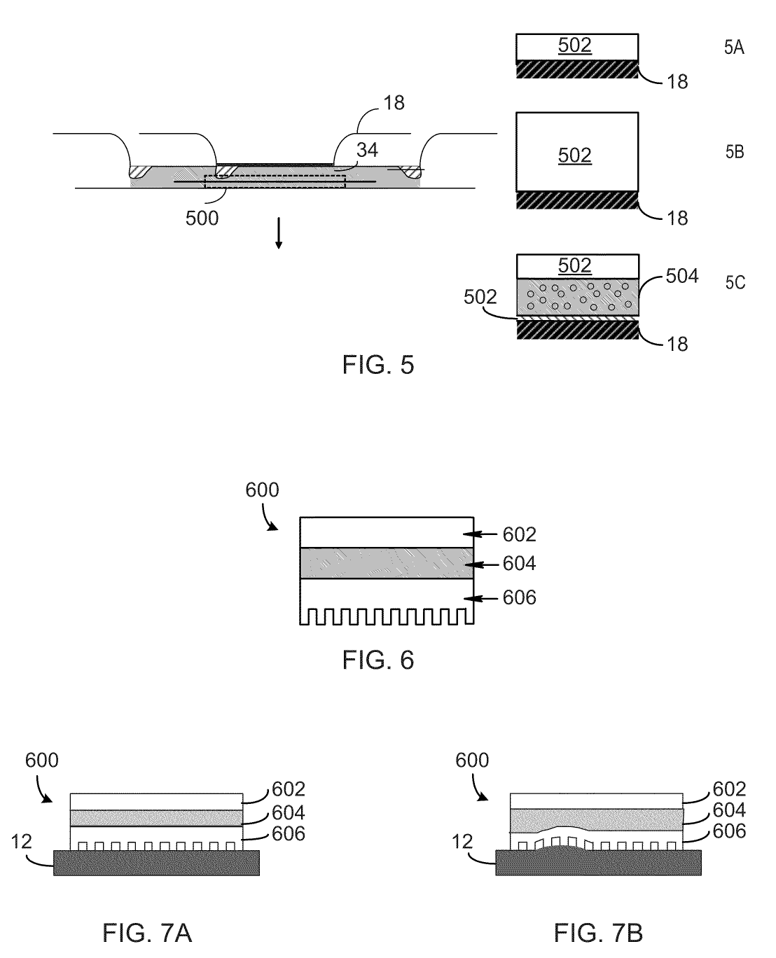

FIG. 5 illustrates polymerizable material 34 between template 18 and imprinting stack 500. The arrow indicates the direction of gas transport into the imprinting stack. Enlarged view 5A illustrates an imprinting stack 500 with substrate 12 and layer 502. Layer 502 may include one or more layers. Layer 502 is not considered to be a porous layer. Layer 502 may include an organic layer. In some cases, a silicon wafer may block helium diffusion, and an organic stack above the silicon may be saturated by helium during a helium purge at the helium pressure used for purging. In some embodiments, as shown by enlarged view 5B, an increased stack thickness may reduce the probability of helium saturation during the helium purge, and thus improve helium absorption capacity. However, the overall stack thickness may need to be in the range of tens of microns before significant impact can be seen. In enlargement 5C, a porous layer 504 may be included in the stack. Porous layer 504 may be, for example, a low-k layer. A thickness of the porous layer 504 may be in the range of 50 nm to few microns depending on the desired use. Pore size control may be a factor in some applications (e.g., fabrication of compact discs) in which, for example, a large pore size is disadvantageous.

In some embodiments, a porous template and a porous imprinting substrate may be used together. For example, a helium-permeable layer may be included in the template and the imprinting substrate. Introducing a porous layer in a template, an imprinting substrate, or a combination thereof may allow some nitrogen and oxygen (e.g., in the air) to escape through the porous layer if the SiO₂ cap layer is sufficiently thin. This may relax some of the requirements of the helium purge (e.g., a reduced-purity helium may be acceptable).

In a drop dispense nano-imprinting process, template 18 may be made of fused silica. For a template made of a rigid material, better imprinting results and a more uniform residual layer may be achieved for flat substrates. If the substrate is not substantially flat, fluid starvation, uneven residue layer, or a combination thereof may result. Furthermore, filling speed may be limited by the escape and dissolution rates of the gases that are trapped at the interstitial regions and inside features of the template.

FIG. 6 depicts a template 600 including a rigid support layer 602, a cushion layer 604, and a cap layer 606. The cap layer 606 may include, for example, a CVD or thermally grown SiO₂ layer. The cushion layer 604 may alleviate the need for a substantially flat substrate. The cushion layer 604 may also increase filling speed by increasing the escape and/or dissolution rates of gases trapped at interstitial regions and inside the feature trenches of the template.

The rigid support layer 602 may provide a foundation for the template 600. With the rigid support layer 602, the template 600 may be secured onto the template chuck by vacuum or other method. The support layer 602 may promote uniform application of the imprint force in the template plane. The support layer 602 may be a fused silica plate, a rigid polymeric plate, or the like. The support layer 602 may be UV transparent and may have suitable mechanical properties. The thickness of the support layer 602 may be between about 10 μm and about 100 mm, or between about 100 μm and about 10 mm.

The cushion layer 604 may be flexible, such that the cushion layer is able to bend, flex, or absorb an impact with little or no cracking, delaminating, or the like. The cushion layer 604 may include industrial plastics, elastomers, other specialty polymers or compounds, or any combination thereof. The cushion layer 604 may be UV transparent. A thickness of the cushion layer 604 may be less than about 10 nm, between about 10 nm and about 100 mm, or between about 1 μm and about 10 mm.

The cap layer 606 is selected to undergo minimal deformation during imprinting. The cap layer 606 may be, for example, SiO₂ or the like. As described in U.S. Pat. No. 5,792,550, which is hereby incorporated by reference herein, SiO₂ may be used as barrier layer on top of a polymeric substrate. The SiO₂ cap layer may act as a barrier to inhibit interaction between the cushion layer and a polymerizable material to be imprinted by the template. The SiO₂ cap layer may also provide desired surface characteristics for wetting by and releasing of the polymerizable material.

FIGS. 7A and 7B illustrate an imprinting process with template 600 including a cushion layer 604. In FIG. 7A, the substrate 12 is substantially even. In FIG. 7B, the substrate 12 is uneven. As seen in FIG. 7B, an uneven substrate 12 may cause deformation of the cap layer 606 and the cushion layer 604, but not the support layer 604.

A thickness of the cap layer 606 may be selected to provide good mechanical support for the features (e.g., protrusions and recessions), to achieve a suitable amount of flexibility, and to allow gas to permeate through the cap layer to the cushion layer 604. If the cap layer 606 is too thick, the template 600 will behave similarly to a template made substantially of fused silica. If the cap layer 606 is too thin, the template 600 may not be strong enough to withstand the imprinting process. A thickness of the cap layer 606 (excluding the feature height) may be between about 1 nm and about 1,000 μm, or between about 10 nm and about 100 μm.

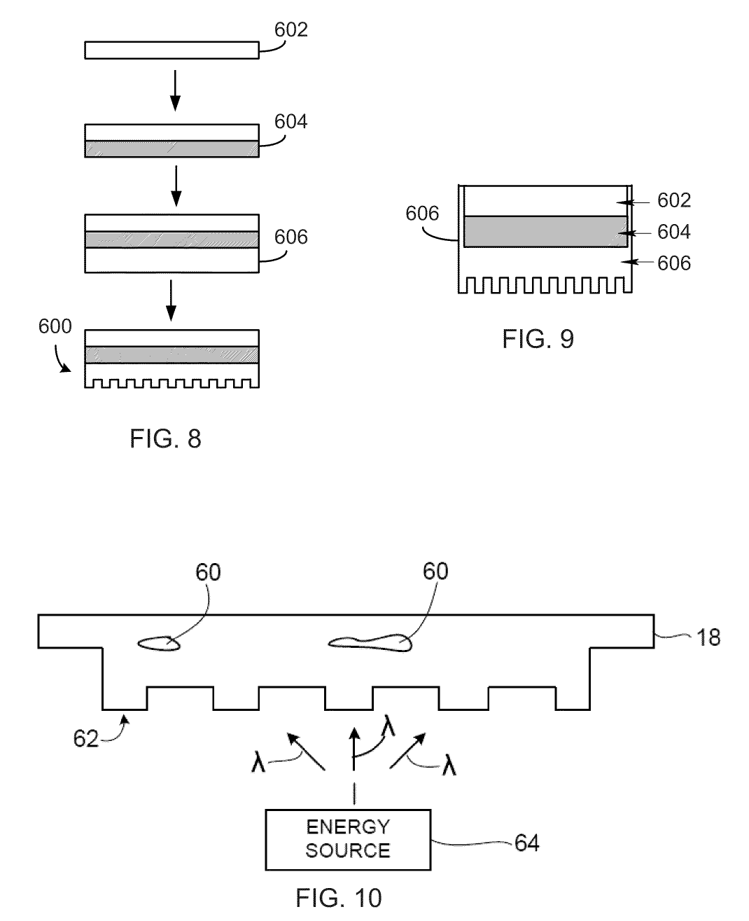

An example of a process for fabricating a template 600 with a cushion layer 604 is illustrated in FIG. 8. As shown in FIG. 8, a cushion layer 604 may be formed on a support layer 602, and a cap layer 606 may be formed on the cushion layer 604. Features may be fabricated in the cap layer 606.

In some embodiments, as illustrated in FIG. 9, a cap layer 606 may be formed on exposed sides of the cushion layer 604, such that the cushion layer is effectively isolated from (e.g., not exposed to) reclaim chemistry (such as Piranha or oxygen plasma reclaim) and other process that may deteriorate the cushion layer during, for example, etching of the template 600.

A cushion layer including a foaming material or other porous material, or fabricated with a foaming material or other porous material, may facilitate transport of gas away from the interstitial regions into the template, dissolution of the gas in the polymerizable material, or any combination thereof, thereby increasing the overall filling speed of the features in the cap layer.

With frequent imprinting, however, templates able to absorb gas may become saturated. Saturation of the template may inhibit further absorption of gas, subsequently resulting in defective imprint patterning. As such, gases present in a template may need a mechanism for desorbing from the template.

Heating template 18 may allow gases 60 to desorb from template 18. Heating may increase permeability of gases 60, thus, allowing gases 60 to desorb into the ambient atmosphere. Additionally, heating template 18 may generally reduce solubility of gases 18 in the template material, aiding in desorption.

Changes in temperature of a template, however, may cause thermal distortions of the patterning surface 22 and/or patterned layer 46 (shown in FIGS. 1 and 2). As such, template 18 may need to be selectively heated.

As illustrated in FIG. 10, selective heating of template 18 may allow for gases 60 to desorb from template 18 while minimizing thermal distortions. Selective heating may be through exposure to wavelength λ, and/or wavelength band λₓ-λ_{y}, from energy source 64. Such selective heating may allow for gases 60 to desorb from template 18. For simplification, but not to be considered limiting, wavelength and/or wavelength band are hereinafter referred to as wavelength λ. A suitable energy source 64 may include, but is not limited to, filament sources with bandpass filters, infrared laser sources, and/or the like.

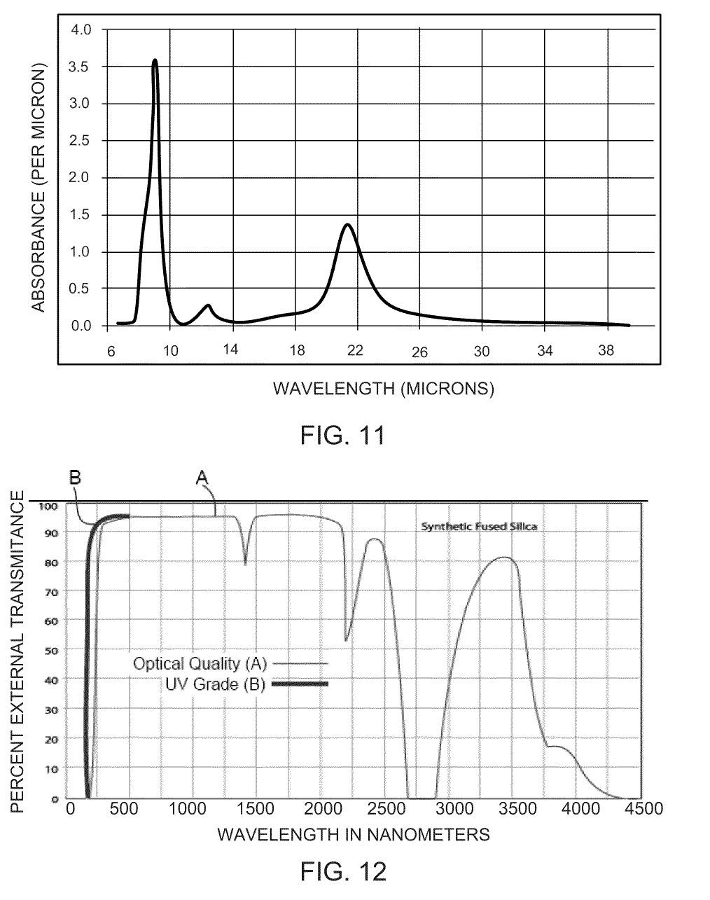

Selection of wavelength λ may depend on the material composition of template 18. For example, template 18 may be formed from fused silica. Fused silica is generally highly transparent at most visible and ultraviolet wavelengths. This may be undesirable as there is generally no heating of template 18 at these wavelengths. Fused silica, however, has several strong absorption bands at infrared wavelengths. As graphically represented in FIGS. 11 and 12, fused silica typically has absorption bands at infrared wavelengths of approximately 2.8 microns, 5-6 microns, 9-10 microns, and 21-23 microns. As such, for selective heating, selection of the wavelength λ for fused silica may include infrared wavelengths of approximately 2.8 microns, 5-6 microns, 9-10 microns, and/or 21-23 microns.

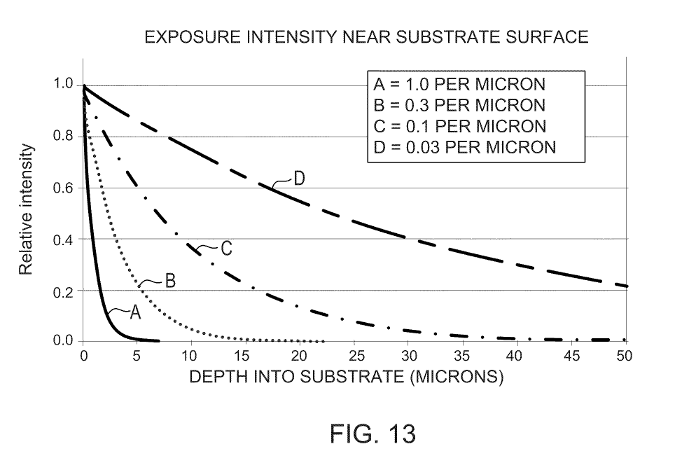

Referring again to FIG. 10, in one embodiment, selective heating may be limited to the surface 62 of template 18. Selectively concentrating the heating of template 18 at surface 62 may further reduce thermal distortions of the patterning surface 22 (shown in FIG. 1) and/or patterned layer 46 (shown in FIG. 2). In this embodiment, the surface 62 of template 18 is heated by a strong absorption band to provide for desorption of gases 60 within template 18. When selective heating is concentrated to the surface 62, selection of the wavelength λ may be further limited to wavelengths at which template material is strongly absorbing. For example, FIG. 13 is a graphical representation of an example exposure intensity of the surface 62 of the template 18 of FIG. 10. The relative intensity of a strong absorption band is generally localized within a few microns of surface 62, as illustrated by Band A, as compared to a weak absorption band that may deeper penetrate the surface 62, as illustrated by Band B. As such, selective heating at surface 62 may follow selection of wavelengths that produce results substantially similar to Band A.

After surface 62 of template 18 is heated, the template 18 may be cooled before the imprinting process is resumed. For example, template 18 may be cooled to a thermal equilibrium sufficient to resume imprinting. Cooling of surface 62 may occur through conduction and/or convection.

Referring again to FIG. 10, in one embodiment, template 18 may be cooled using conduction of heat between surface 62 and substrate 12. Prior to dispensing polymeric material between template 18 and substrate 12, as described with respect to FIG. 1, template 18 may be placed into contact with substrate 12 such that heat transfers from template 18 to substrate 12.

In another embodiment, surface 62 and/or template 18 may be immersed in a fluid having high thermal conductivity and/or heat capacity to draw heat from the template 18. For example, template 18 may be immersed in helium gas, which has high thermal conductivity and heat capacity compared to atmospheric air.

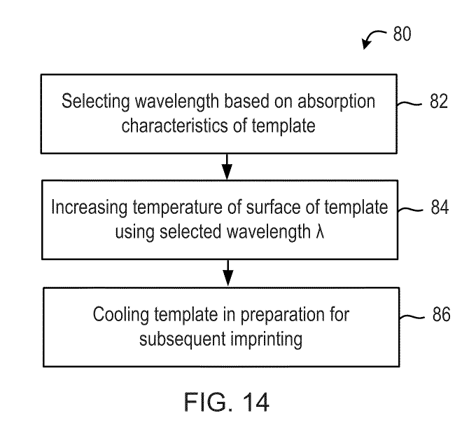

FIG. 14 illustrates a flow chart 80 of an example of a method for selective heating of template 18 for desorption of gases 60. In a step 82, a wavelength λ for exposure may be selected based on one or more absorption characteristics of template 18. In a step 84, surface 62 of template 18 may be exposed to selected wavelength λ to increase the temperature of surface 62. Increasing the temperature of surface 62 may increase permeability of gases 60 through template 18. In a step 86, template 18 may be cooled in preparation for subsequent imprinting.

What is claimed is:

1. A nano-imprint lithography template comprising:
a rigid support layer;
a nano-imprint lithography cap layer having features configured to imprint a pattern within a polymerizable liquid; and
a flexible cushion layer positioned between the support layer and the cap layer.

2. The template of claim 1, wherein the cushion layer is configured to absorb forces from an uneven substrate during a nano-imprinting process such that the support layer is substantially undeformed during the process.

3. The template of claim 1, wherein the cushion layer comprises an elastomer.

4. The template of claim 1, wherein the cushion layer is substantially UV transparent.

5. A method of treating a nano-imprint lithography template in a nano-imprint lithography system, the method comprising heating the nano-imprint lithography template to remove adsorbed gas from the nano-imprint lithography template.

6. The method of claim 5, wherein heating comprises irradiating the template with radiation of a selected wavelength.

7. The method of claim 6, wherein the template is irradiated with radiation of a wavelength corresponding to an absorption band of the template.

8. The method of claim 6, wherein the template comprises fused silica, and wherein the radiation is infrared radiation.

9. The method of claim 8, wherein a wavelength of the infrared radiation is between about 2 microns and about 23 microns.

10. The method of claim 9, wherein the wavelength of the infrared radiation is selected from the group consisting of 2.8 microns, 5-6 microns, 9-10 microns, 21-23 microns, and any combination thereof.

11. The method of claim 5, wherein heating comprises irradiating with an infrared laser.

12. The method of claim 5, wherein heating comprises irradiating with a filament source.

13. The method of claim 5, wherein heating comprises selectively heating near a surface of the template.

14. The method of claim 5, further comprising cooling the template after heating.

15. The method of claim 14, wherein cooling comprises contacting a surface with the template such that heat transfers from the template to the surface.

16. The method of claim 15, wherein the surface comprises an imprint lithography substrate, and the substrate is coupled to an imprint lithography system.

17. The method of claim 14, wherein cooling comprises contacting the template with a fluid.

18. The method of claim 17, wherein contacting comprises immersing at least a portion of the template in the fluid.

19. A nano-imprint lithography method comprising:
depositing a first portion of polymerizable material on a first nano-imprint lithography substrate;
contacting the first portion of the polymerizable material with a nano-imprint lithography template coupled to a nano-imprint lithography system;
solidifying the polymerizable material;
separating the nano-imprint lithography template from the solidified material;
heating the nano-imprint lithography template to remove adsorbed gases from the nano-imprint lithography template;
cooling the nano-imprint lithography template to ambient temperature;
depositing a second portion of polymerizable material on a second nano-imprint lithography substrate;
contacting the second portion of the polymerizable material with the cooled nano-imprint lithography template;
solidifying the polymerizable material; and
separating the nano-imprint lithography template from the solidified material.

20. The method of claim 19, wherein the first substrate and the second substrate are the same.
